(19) United States
(12) Patent Application Publication
(10) Pub. No.: US 2025/0269490 A1
(43) Pub. Date: Aug. 28, 2025

(54) AUTOMATIC BURNISHING SYSTEM FOR PREPARING GLASS SURFACE FOR SOLDERING

(71) Applicant: Magna Exteriors, Inc., Troy, MI (US)

(72) Inventors: John C. Nelson, III, Holland, MI (US); Drew C. Pretzer, Holland, MI (US); Trevor M. Gelfius, Grandville, MI (US); David M. King, Hudsonville, MI (US); Benjamin R. Wood, Norton Shores, MI (US)

(21) Appl. No.: 19/062,298

(22) Filed: Feb. 25, 2025

Related U.S. Application Data
(60) Provisional application No. 63/558,772, filed on Feb. 28, 2024.

(51) Int. Cl. B24B 41/00; B24B 29/02; B25J 11/00

(52) U.S. Cl. CPC B24B 41/005; B24B 29/02; B25J 11/0065

(57) ABSTRACT

A vehicular window burnishing system includes an articulating robot having an end-of-arm-tool (EOAT) disposed at an end of an arm. With a glass panel of a vehicular window assembly secured relative to the robot, the robot is operable to move the arm to adjust positioning of a burnishing wheel relative to the glass panel. A sensor senses at least a portion of the glass panel and generates sensor data. The system, with the glass panel of the vehicular window assembly secured relative to the articulating robot, and based at least in part on processing of sensor data generated by the sensor, operates the articulating robot to move the arm and engage the burnishing wheel with an electrical terminal disposed at the surface of the glass panel and operates the EOAT to rotatably drive the burnishing wheel to at least partially remove an oxidation layer at the electrical terminal.

### CROSS REFERENCE TO RELATED APPLICATION

The present application claims the filing benefits of U.S. provisional application Ser. No. 63/558,772, filed Feb. 28, 2024, which is hereby incorporated herein by reference in its entirety.

### FIELD OF THE INVENTION

The present invention relates to a window assembly for a vehicle and, more particularly, a window assembly with an electronic component disposed thereat.

### BACKGROUND OF THE INVENTION

It is known to provide a window assembly for an opening of a vehicle where the window assembly has one or more electrical components disposed at a glass panel of the window assembly. For example, glass window panels often have a heating element established thereat to defog or defrost the window panel. The heating element typically includes respective heater grids that are electrically connected to a power source and heated responsive to actuation of a user input. Individual electrical connectors are soldered at the heater grids or busbars at the glass window panel and are configured to connect to the vehicle wire harness when the window assembly is installed.

### SUMMARY OF THE INVENTION

A system for preparing a glass surface for soldering, such as during manufacture of a vehicular window assembly, includes an articulating robot having an arm and an end-of-arm-tool (EOAT) disposed at an end of the arm. The EOAT includes a burnishing wheel and the EOAT is operable to rotatably drive the burnishing wheel. With a glass panel of the vehicular window assembly fixed relative to the articulating robot, the articulating robot is operable to move the arm to adjust positioning of the burnishing wheel relative to a surface of the glass panel. An electrical terminal is disposed at the surface of the glass panel and the electrical terminal is electrically conductively connected to an electronic component of the vehicular window assembly. A vision sensor, with the glass panel of the vehicular window assembly fixed relative to the articulating robot, views at least a portion of the glass panel and generates sensor data. An electronic control unit (ECU) includes a data processor for processing sensor data generated by the vision sensor. The system, with the glass panel of the vehicular window assembly fixed relative to the articulating robot, and based on processing at the ECU of sensor data generated by the vision sensor, operates the articulating robot to move the arm and engage the burnishing wheel with the electrical terminal at the surface of the glass panel. The system, with the burnishing wheel engaged with the electrical terminal at the surface of the glass panel, operates the EOAT to rotatably drive the burnishing wheel to remove an oxidation layer at the electrical terminal.

These and other objects, advantages, purposes and features of the present invention will become apparent upon review of the following specification in conjunction with the drawings.

### BRIEF DESCRIPTION OF THE DRAWINGS

FIG. 1 is a rear perspective view of a pickup truck having a rear slider window assembly having a heater grid disposed at the glass panel of the window assembly;

FIGS. 2A-2C show a robot equipped with a burnishing wheel tool as the robot operates to remove an oxidation layer from an electrical terminal at the glass panel of the window assembly; and

FIGS. 3-5 are views of the robot equipped with the burnishing wheel tool.

### DESCRIPTION OF THE PREFERRED EMBODIMENTS

Electrically connecting an electrical component, such as a heater grid or lighting device or movable panel drive system or an antenna or a glass/panel breakage sensor, or the like, of a vehicular window assembly to a power source of a vehicle may include providing a direct electrical connection at a glass panel of the window assembly. For example, the electrical component may include an electrical terminal disposed at the glass panel (such as at an electrically conductive trace or busbar established at a surface of the glass panel) and configured for electrical connection with a power source of the vehicle (such as via an electrical connector configured to connect to a wire harness of the vehicle). Solder (such as solder paste or a solder pad) may be positioned at the electrical terminal and heated so that the solder melts between the electrical connector and the terminal at the glass panel and is subsequently cooled to harden to form a solder joint between the electrical connectors and the terminal at the panel (such as between the electrical connectors and the electrically conductive trace or busbar established at the surface of the glass panel). Before the soldering process is performed, an oxidation layer may be present at the electrical terminals at the glass panel.

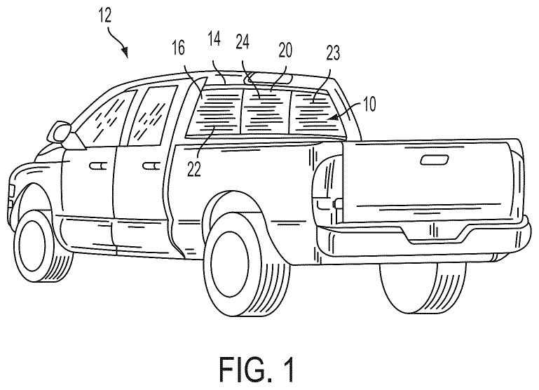

Referring now to the drawings and the illustrative embodiments depicted therein, FIG. 1 depicts an example of a vehicular window assembly having at least one electrical component disposed at a glass panel of the window assembly. FIG. 1 depicts a rear slider window assembly 10 of a vehicle 12 (such as a pickup truck or the like) that includes a window frame 14 (having upper and lower rails), and a fixed window panel 16 having an opening or aperture 18 disposed between a first or left-side portion 16a of the fixed window panel 16 and a second or right-side portion 16b of the fixed window panel 16. In some examples, the fixed window panel 16 comprises a pair of side fixed window panels with the opening disposed between and separating the pair of side fixed window panels. A movable window panel 20 is movable relative to the frame 14 and the fixed window panel 16 between an opened position and a closed position. The left-side portion 16a and the right-side portion 16b of the fixed window panel 16 each include an electrically conductive heater grid 22, 23 or other heating element or electrically operable element or device disposed at or established at the window panel portions (such as at or on an interior surface of the window panel), and the movable window panel 20 includes an electrically conductive heater grid or other heating element or electrically operable element or device 24 disposed at or established at the window panel (such as at or on an interior surface of the movable window panel). The window assembly may include a drive system that is electrically operable to move the movable window panel 20 relative to the fixed window panel 16 between the closed position, where the movable window panel is disposed at the opening 18 between the fixed window panel portions, and the closed position, where the movable window panel is disposed at least partially along one of the fixed window panel portions.

The heater grids 22, 23 are electrically conductively connected to (or are otherwise in electrical conductive continuity with) a power source of the vehicle and may be powered (such as responsive to a user actuatable input or switch or button of the vehicle or responsive to a sensor or accessory of the vehicle) to heat or defrost or defog the fixed window panel 16. The movable panel heater grid 24 is electrically connected to the power source (and may be electrically connected to electrical terminals or elements at one of the heater grids 22, 23 of the fixed window panel) and may be electrically powered to heat or defrost or defog the movable window panel 20. The electrical connections between the respective electrical components at the glass panels of the window assembly (e.g., the heater grids) comprise solder joints formed by heating a button or electrical connector disposed at the glass panel and/or heating the solder that is disposed at the interface side of the electrical connector or at the glass panel so as to be between and joining the electrical connector and the electrical terminal or electrically conductive trace or busbar at the glass panel. For example, the electrical connectors may comprise buttons that are configured to snap attach to a corresponding connector of the vehicle wire harness or to a connector or jumper wire of the window assembly or may comprise spade connectors that are configured to be received in (or receive) a corresponding connector of the vehicle wire harness or a connector or jumper wire.

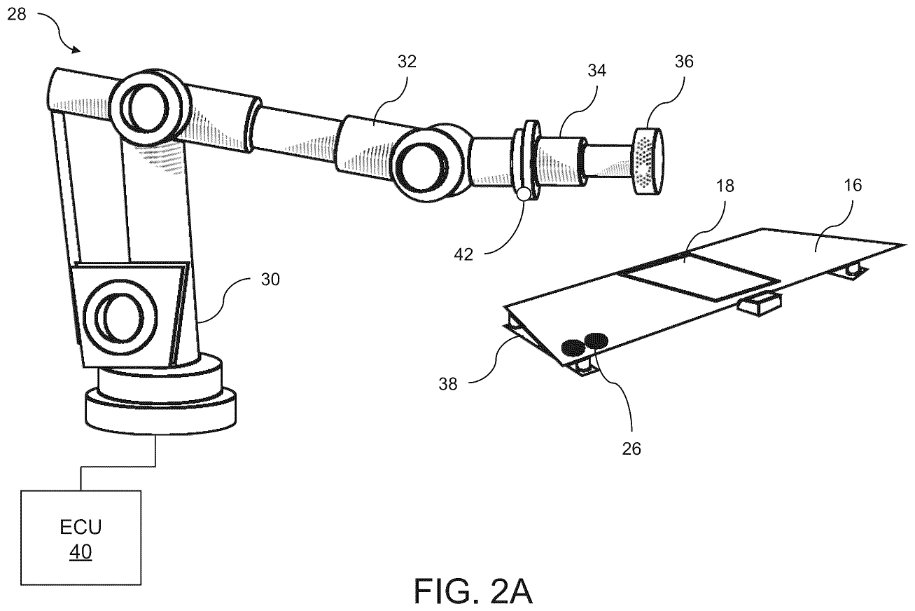

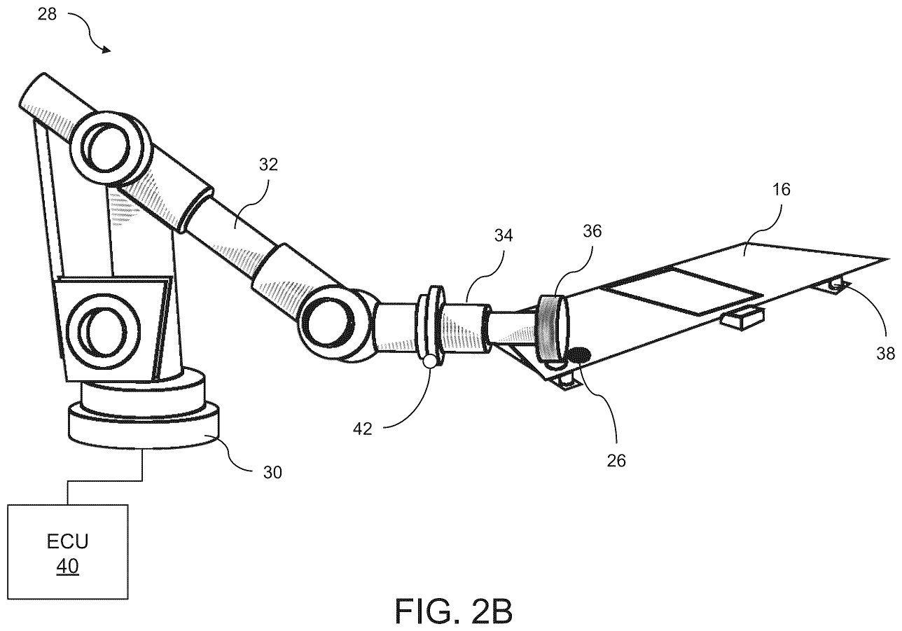

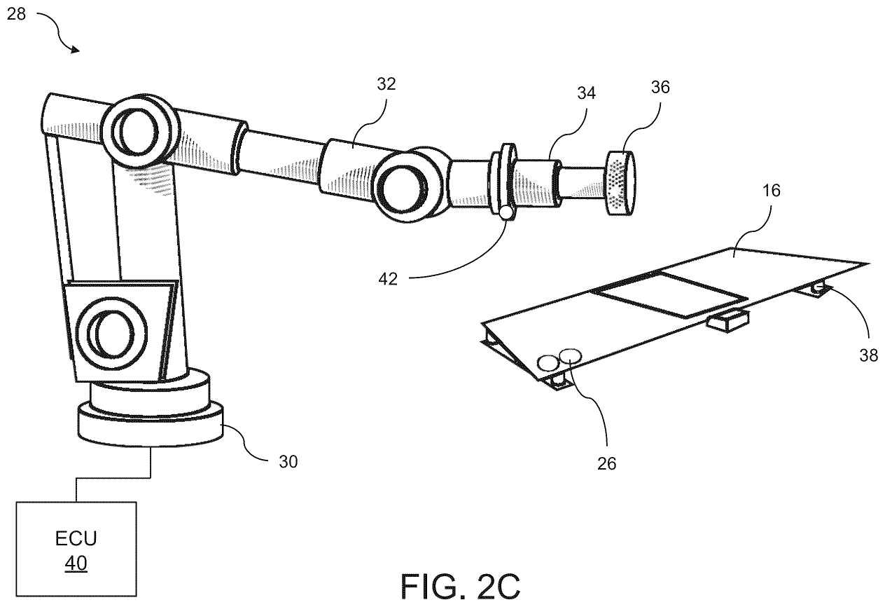

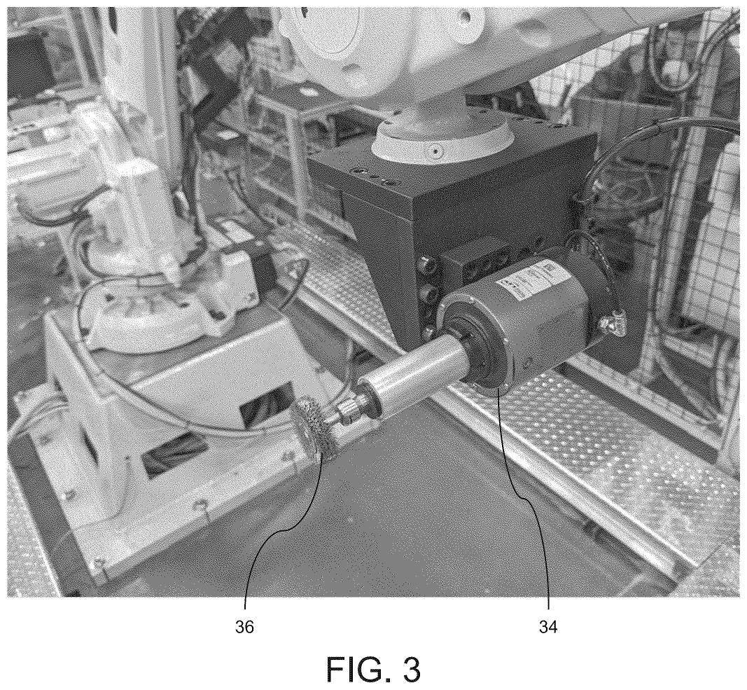

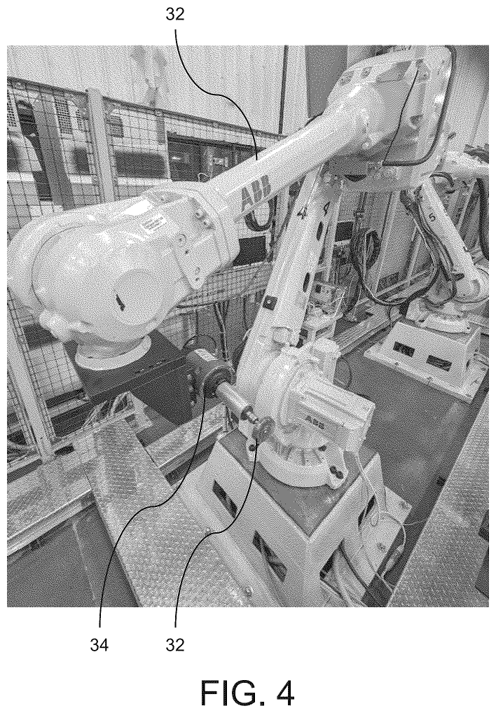

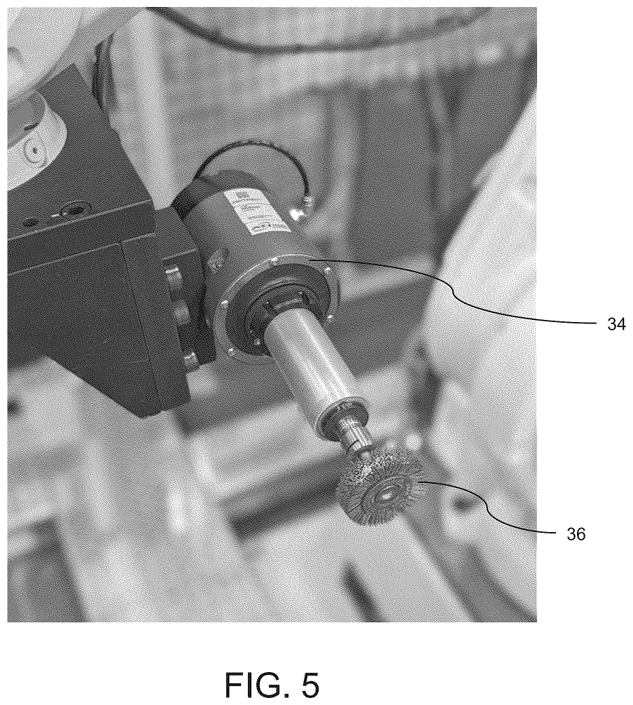

As shown in FIGS. 2A-5, prior to heating the solder and attaching the electrical connector at an electrical terminal 26 of the heater grid or other electrically operable component at the glass panel, the window panel may be prepared by removing an oxidation layer from the electrical terminal 26. A system 28 for preparing the window panel during assembly of the vehicular window assembly includes an articulated robot 30 having a movable arm 32 and an end-of-arm tool (EOAT) 34 disposed at an end of the movable arm 32. As described further below, the robot 30 is operable to move the arm 32 and the EOAT 34 relative to the glass panel 16 so that the EOAT 34 may be operated to remove the oxidation layer from the electrical terminal 26 at the glass panel 16. The EOAT 34 in the illustrated example includes a burnishing wheel tip 36 having an abrasive surface (e.g., wire brush) that is rotatably driven and engaged with the electrical terminal 26 to remove the oxidation layer. Optionally, the EOAT 34 may include any suitable tool for removing the oxidation layer, such as a polishing wheel, buffing pad or a sprayer nozzle (e.g., for directing pressurized air, fluid or chemicals, or for sandblasting). Although shown and described as removing the oxidation layer from the electrical terminal 26 at the fixed glass panel 16 of the window assembly 10, it should be understood that the system 28 may be suitable for removing the oxidation layer from electrical terminals at other glass panels and surfaces, such as the left and right side window panels, the movable window panel, a windshield panel, a fixed rear window panel, front and rear door window panels, quarter window panels, vehicular body panels, other vehicular surfaces and the like. Further, the system 28 may be suitable for removing oxidation from electrical terminals at non-vehicular surfaces, such that the system 28 may be used during assembly of non-vehicular components.

During removal of the oxidation layer from the electrical terminals 26, the window panel 16 is fixed relative to the robot 30. For example, the window panel 16 may be disposed at or mounted to suction cups 38 or other suitable fixturing structure (FIG. 2A). The window panel 16 may be fixed at a known or repeatable position relative to the robot 30.

With the window panel 16 fixed relative to the robot 30, the arm 32 is moved and the EOAT 34 is operated to bring the rotating burnishing wheel 36 toward engagement with the electrical terminal 26 (FIG. 2B). The burnishing wheel may have a grit value that removes only oxidation from the glass surface. In other words, when the rotating burnishing wheel is engaged with the electrical terminal 26 and/or the glass surface, the burnishing wheel is configured to remove oxidation from the electrical terminal 26 at the glass surface and to not remove other layers or materials at the glass surface (e.g., portions of the heater grid disposed at the glass surface, darkened or tinted films or layers at the glass surface, and the like). For example, the grit value of the burnishing wheel may be at least 100 grit, such as between 100 grit and 800 grit, such as, for example, about 500 grit. The burnishing wheel may be operated at any suitable orientation relative to the glass surface. For example, the burnishing wheel may rotate about an axis that is generally parallel to the glass surface (e.g., a horizontal spin axis), or the burnishing wheel may rotate about an axis that is generally perpendicular to the glass surface (e.g., a vertical spin axis), or any other suitable axis orientation relative to the glass surface. As the rotating burnishing wheel 36 engages the electrical terminal 26, the oxidation layer is removed (FIG. 2C). With the oxidation layer removed, the window panel 16 may be removed from the suction cups 38, or the window panel 16 may remain at the suction cups 38 for further assembly (e.g., the soldering process).

Operation of the robot 30 may be controlled via user inputs, stored instructions, and/or sensor inputs. That is, a user may provide inputs (e.g., at a joystick or other user interface) that control movement of the arm 32 and operation of the EOAT 34 to remove the oxidation layer. In some examples, the robot 30 may be programmed (e.g., instructions may be stored in memory in communication with driver circuitry at the robot 30) to move the arm 32 relative to the window panel 16 and operate the EOAT 34 to remove the oxidation layer. In other words, the robot 30 may include or be in communication with an electronic control unit (ECU) 40 that includes electronic circuitry and associated software. The ECU 40 may operate the robot 30 based on stored instructions and/or based on processing of sensor data. For example, the window panel 16 may be fixed relative to the robot 30 so that the electrical terminal 26 is in a known and repeatable position and the arm 32 is moved to position the rotating burnishing wheel 36 relative to the electrical terminal 26 for a threshold period of time configured to remove the oxidation layer. Movement of the arm 32 and EOAT 34 relative to the window panel 16 may be based on closed-loop feedback from motors of the arm 32. The system may include an actuator (such as a pneumatic motor compensator) that controls the amount of pressure applied to the glass surface when the burnishing wheel is operated to remove oxidation.

Optionally, the robot 30 may include or be in communication with a vision or sensor system and operation of the robot 30 may be based on processing of sensor data captured by the vision or sensor system. For example, a camera or other suitable sensor 42 (e.g., an infrared sensor, an ultrasonic sensor, a radar sensor, and the like) may be disposed at or near the EOAT 34 for determining a position of the arm 32 and EOAT 34 relative to the window panel 16. That is, sensor data captured by the camera 42 may be processed for positioning the EOAT 34 and rotating burnishing wheel 36 relative to the electrical terminal 26. Further, sensor data captured by the camera 42 may be processed for determining removal of the oxidation layer. Optionally, the down pressure of the burnishing wheel at the glass surface may be adjusted based in part on processing of sensor data captured by the camera or sensor. For example, the rotating burnishing wheel 36 may be engaged with the electrical terminal 26 until it is determined that the oxidation layer has been removed, such as based on a determined change in surface appearance (e.g., color, finish, and the like) of the electrical terminal 26. After the EOAT 34 is moved away from the window panel 16, sensor data may be processed to determine whether any further removal of the oxidation layer is needed. That is, based on processing of further sensor data, the system may reengage the burnishing wheel 36 to remove additional oxidation.

Thus, an example method of preparing a glass window panel having an electrically operable component (e.g., a heater grid, a lighting module, a panel drive system, and the like) for a soldering process includes providing the glass window panel 16 fixed or secured relative to the articulating robot 30. With the glass window panel 16 fixed or secured relative to the robot 30 and with an oxidation layer present at the electrical terminal 26 at the glass window panel 16, the robot 30 is operated to move the arm 32 and position the EOAT 34 and burnishing wheel 36 at or near the electrical terminal 26. For example, the EOAT 34 may be positioned at or near the electrical terminal 26 based on a known position of the window panel 16 and electrical terminal 26 relative to the robot 30 and/or based on processing of sensor data captured by the camera 42 at or near the EOAT 34. The EOAT 34 is operated to rotatably drive the burnishing wheel 36 and the rotating burnishing wheel 36 is engaged with the electrical terminal 26 to remove the oxidation layer. After the oxidation layer is at least partially removed from the electrical terminal 26 (e.g., after a threshold period of time or after determination that the oxidation layer is removed based on processing of sensor data), the arm 32 and the EOAT 34 is moved away from engagement with the electrical terminal 26. Optionally, based on determination that at least some of the oxidation layer remains at the electrical terminal 26, the robot 30 is operated to engage the burnishing wheel 36 at or near the terminal 26 to further remove the oxidation layer, and this process may be repeated as necessary to sufficiently remove the oxidation layer (e.g., to remove 90 percent or more of the oxidation layer, to remove 95 percent or more of the oxidation layer, and the like). The window panel 16 may then be moved for further processing or the window panel 16 may remain fixed for the automated soldering process.

In other words, the system uses the robot with a driver EOAT with a burnishing wheel tip mounted to the end to remove the oxidation layer from the terminal points on the heater grid adhered prior to the automated solder application being performed. The process is controllable using a regulated input on the driver collar and its quality is checked using vision after the process is completed.

The system may be operable to remove oxidation from electrical terminals at any suitable vehicular window assembly having any suitable electrical component disposed thereat. For example, the window assembly having an electronic component disposed thereat may comprise a vehicular rear window assembly having an electrically operable heater grid disposed thereat, such as described in U.S. Pat. Nos. 10,843,644; 10,524,313; 9,579,955; 8,881,458 and/or 8,402,695, and/or U.S. Pub. Nos. US-2022-0295603; US-2021-0070241 and/or US-2021-0039481, which are all hereby incorporated herein by reference in their entireties, or a vehicular window assembly having an integrated lighting component, such as described in U.S. Pat. Nos. 10,501,008 and/or 9,896,026 and/or U.S. Publication No. US-2022-0072992, which is hereby incorporated herein by reference in its entirety, or a vehicular window assembly having an integrated camera and/or lighting component, such as described in U.S. Pat. No. 10,668,868, which is hereby incorporated herein by reference in its entirety, or a vehicular window assembly having an integrated touch or proximity sensor and/or display, such as described in U.S. Pat. Nos. 10,559,153 and/or 10,427,503, which are hereby incorporated herein by reference in their entireties, or a vehicular rear slider window assembly having a movable panel drive system disposed thereat for moving a slider window panel relative to one or more fixed window panels, such as described in U.S. Pat. Nos. 4,920,698; 4,995,195; 5,146,712; 5,531,046; 5,572,376; 6,119,401; 6,955,009; 7,073,293 and/or 10,501,977, and/or U.S. Publication Nos. US-2019-0383084; US-2008-0127563 and/or US-2004-0020131, which are all hereby incorporated herein by reference in their entireties, or a vehicular window assembly, such as a glass roof panel, having an electrically operable dimming or shadowing layer that adjusts the tint of the glass according to an electrical current applied to the layer at the glass panel, or a vehicular window assembly having an integrated antenna or an integrated glass/panel breakage sensor (for example, a loop of silver or other electrically conductive material may be applied to the glass panel so that when the resistance through the loop changes (due to broken glass), it can set off an alarm of the vehicle), or the like.

The automated soldering process may include characteristics of the systems and processes described in U.S. Publication No. US-2023-0339034, which is hereby incorporated herein by reference in its entirety.

Optionally, the window assembly or assemblies may utilize aspects of the window assemblies described in U.S. Pat. Nos. 11,746,582; 11,331,984; 10,501,977; 8,938,914; 8,915,018; 8,881,458; 8,402,695; 8,322,073; 8,048,529; 7,838,115; 7,332,225; 7,073,293; 7,003,916; 6,846,039; 6,691,464; 6,319,344; 6,068,719; 5,853,895 and/or 5,799,444, and/or U.S. Publication Nos. US-2014/0047772; US-2006-0107600; US-2008-0127563; US-2004-0020131 and/or US-2003-0213179, which are hereby incorporated herein by reference in their entireties.

Changes and modifications to the specifically described embodiments may be carried out without departing from the principles of the present invention, which is intended to be limited only by the scope of the appended claims, as interpreted according to the principles of patent law.

1. A vehicular window burnishing system, the vehicular window burnishing system comprising:
an articulating robot comprising an arm and an end-of-arm-tool (EOAT) disposed at an end of the arm, wherein the EOAT comprises a burnishing wheel, and wherein the EOAT is operable to rotatably drive the burnishing wheel;
wherein, with a glass panel of a vehicular window assembly secured relative to the articulating robot, the articulating robot is operable to move the arm to adjust positioning of the burnishing wheel relative to a surface of the glass panel;
wherein an electrical terminal is disposed at the surface of the glass panel, and wherein the electrical terminal is electrically conductively connected to an electronic component of the vehicular window assembly;
a sensor, wherein, with the glass panel of the vehicular window assembly secured relative to the articulating robot, the sensor senses at least a portion of the glass panel, and wherein the sensor generates sensor data;
an electronic control unit (ECU) comprising a data processor for processing sensor data generated by the sensor;
wherein, with the glass panel of the vehicular window assembly secured relative to the articulating robot, and based at least in part on processing at the ECU of sensor data generated by the sensor, the vehicular window burnishing system operates the articulating robot to move the arm and engage the burnishing wheel with the electrical terminal at the surface of the glass panel; and
wherein, with the burnishing wheel engaged with the electrical terminal at the surface of the glass panel, the vehicular window burnishing system operates the EOAT to rotatably drive the burnishing wheel to at least partially remove an oxidation layer at the electrical terminal.

2. The vehicular window burnishing system of claim 1, wherein the vehicular window burnishing system operates the EOAT to rotatably drive the burnishing wheel for a predetermined threshold period of time.

3. The vehicular window burnishing system of claim 1, wherein, with the burnishing wheel engaged with the electrical terminal at the surface of the glass panel, and based at least in part on processing at the ECU of sensor data generated by the sensor, the vehicular window burnishing system operates the EOAT to rotatably drive the burnishing wheel to at least partially remove the oxidation layer at the electrical terminal.

4. The vehicular window burnishing system of claim 3, wherein, based on determination that the oxidation layer has been removed from the electrical terminal, the vehicular window burnishing system ceases operating the EOAT to rotatably drive the burnishing wheel, and wherein determination that the oxidation layer has been removed from the electrical terminal is based on processing at the ECU of sensor data generated by the sensor.

5. The vehicular window burnishing system of claim 1, wherein the sensor comprises an imaging sensor, and wherein the sensor data is representative of a surface appearance at the electrical terminal at the surface of the glass panel.

6. The vehicular window burnishing system of claim 1, wherein the vehicular window burnishing system, based on determination that the oxidation layer has been removed from the electrical terminal, operates the articulating robot to move the arm and to move the burnishing wheel away from the electrical terminal at the surface of the glass panel.

7. The vehicular window burnishing system of claim 1, wherein, with the oxidation layer at least partially removed from the electrical terminal, the electrical terminal is configured to receive solder for electrically conductively connecting the electrical terminal and an electrical connector configured to electrically conductively connect to a power source of a vehicle equipped with the vehicular window assembly.

8. The vehicular window burnishing system of claim 1, wherein the electronic component of the vehicular window assembly comprises a heating grid.

9. The vehicular window burnishing system of claim 1, wherein the electronic component of the vehicular window assembly comprises a lighting device.

10. The vehicular window burnishing system of claim 1, wherein the electronic component of the vehicular window assembly comprises a movable panel drive system.

11. The vehicular window burnishing system of claim 1, wherein the electronic component of the vehicular window assembly comprises an antenna.

12. The vehicular window burnishing system of claim 1, wherein the electronic component of the vehicular window assembly comprises a glass breakage sensor.

13. The vehicular window burnishing system of claim 1, wherein the vehicular window assembly comprises a vehicular rear window assembly configured to be disposed at a rear portion of a cabin of a pickup truck.

14. The vehicular window burnishing system of claim 13, wherein the vehicular rear window assembly comprises a fixed window panel having an opening and a movable window panel that is movable between a closed position, where the movable window panel is disposed at the opening, and an opened position, where the movable window panel is disposed at least partially along the fixed window panel, and wherein a drive system is electrically operable to move the movable window panel between the closed position and the opened position.

15. A method for assembling a vehicular window assembly, the method comprising:
providing a glass panel of a vehicular window assembly, wherein an electrical terminal is disposed at a surface of the glass panel, and wherein the electrical terminal is electrically conductively connected to an electronic component of the vehicular window assembly;
securing the glass panel of the vehicular window assembly relative to an articulating robot;
wherein the articulating robot comprises an arm and an end-of-arm-tool (EOAT) disposed at an end of the arm, and wherein the EOAT comprises a burnishing wheel, and wherein the EOAT is operable to rotatably drive the burnishing wheel;
with the glass panel of the vehicular window assembly secured relative to the articulating robot, operating the articulating robot to move the arm to adjust positioning of the burnishing wheel relative to the surface of the glass panel;
wherein, with the glass panel of the vehicular window assembly secured relative to the articulating robot, a sensor senses at least a portion of the glass panel, and wherein the sensor is configured to generate sensor data;
wherein an electronic control unit (ECU) comprises a data processor for processing sensor data generated by the sensor;
with the glass panel of the vehicular window assembly secured relative to the articulating robot, and based at least in part on processing at the ECU of sensor data generated by the sensor, operating the articulating robot to move the arm to adjust positioning of the burnishing wheel relative to the surface of the glass panel;
wherein operating the articulating robot to move the arm comprises engaging the burnishing wheel with the electrical terminal at the surface of the glass panel; and
with the burnishing wheel engaged with the electrical terminal at the surface of the glass panel, and based at least in part on processing at the ECU of sensor data generated by the sensor, operating the EOAT to rotatably drive the burnishing wheel to at least partially remove an oxidation layer at the electrical terminal.

16. The method of claim 15, wherein operating the EOAT to rotatably drive the burnishing wheel is performed for a predetermined threshold period of time.

17. The method of claim 15, further comprising, based on determination that the oxidation layer has been removed from the electrical terminal, ceasing operation of the EOAT to rotatably drive the burnishing wheel, and wherein determination that the oxidation layer has been removed from the electrical terminal is based on processing at the ECU of sensor data generated by the sensor.

18. The method of claim 15, wherein the sensor comprises an imaging sensor, and wherein the sensor data is representative of a surface appearance at the electrical terminal at the surface of the glass panel.

19. The method of claim 15, further comprising, with the oxidation layer at least partially removed from the electrical terminal, applying solder at the electrical terminal for electrically conductively connecting the electrical terminal and an electrical connector configured to electrically conductively connect to a power source of a vehicle equipped with the vehicular window assembly.

20. The method of claim 15, wherein the electronic component of the vehicular window assembly comprises one selected from the group consisting of (i) a heating grid, (ii) a lighting device, (iii) a movable panel drive system, (iv) an antenna and (v) a glass breakage sensor.

21. The method of claim 15, wherein the vehicular window assembly comprises a vehicular rear window assembly configured to be disposed at a rear portion of a cabin of a pickup truck.

22. The method of claim 21, wherein the vehicular rear window assembly comprises a fixed window panel having an opening and a movable window panel that is movable between a closed position, where the movable window panel is disposed at the opening, and an opened position, where the movable window panel is disposed at least partially along the fixed window panel, and wherein a drive system is electrically operable to move the movable window panel between the closed position and the opened position.
